(19) United States
(12) Patent Application Publication
(10) Pub. No.: US 2011/0302483 A1
(43) Pub. Date: Dec. 8, 2011

(54) FORMS INTEGRATION TOOLKIT

(76) Inventor: Walter Greenberg, Alpharetta, GA (US)

(21) Appl. No.: 13/154,434

(22) Filed: Jun. 6, 2011

Related U.S. Application Data
(60) Provisional application No. 61/351,345, filed on Jun. 4, 2010.

(51) Int. Cl. G06F 17/00

(52) U.S. Cl. 715/222

(57) ABSTRACT

The invention is a Forms Integration Toolkit (FIT) application, which is a zero-footprint software toolset that allows users to create forms without the need for software development. The FIT consists of a two-module forms tool and a two-module wizard tool. The forms tool modules are the FIT Configuration Manager and the FIT viewer. The FIT Wizard modules are the Wizard Configuration Manager and the Wizard Viewer. Several unique features differentiate the FIT from other forms tools on the market including the ability to specify a form and mapping instructions for populating multiple targets, including databases and web-services, with information received through the form in a single submit event.

### REFERENCE TO RELATED APPLICATION

This application claim priority to commonly owned U.S. Provisional Patent Application Ser. No. 61/351,345, entitled “Forms Integration Toolkit,” which is incorporated by reference.

### TECHNICAL FIELD

The present invention is generally related to the field of information technology and, more particularly, to data acquisition.

### BACKGROUND OF THE INVENTION

There are presently form building tools available that require various levels of skill to assemble and deploy a form to end-users, then collect the entered information and post such information to a database or web-service. The opportunity we recognized was the need for a Forms toolkit that was entirely contained within the JSR-286 Portlet specification, could be installed into a JSR-286 compliant portal with no database requirement, would allow users with no development skills to use a graphical interface to build complex forms, and lastly to permit the user to submit the collected data to multiple targets, specifically databases and web-services through multiple mapped submit actions.

### SUMMARY OF THE INVENTION

The present invention meets the needs described above in a Forms Integration Toolkit (FIT) application, which is a zero-footprint software toolset that allows a user to create a from without the need for software development. The invention consists of a two-module forms tool and a two-module wizard tool. The forms tool modules are the FIT Configuration Manager and the FIT viewer. The FIT Wizard modules are the Wizard Configuration Manager and the Wizard Viewer. Several unique features differentiate the FIT from other forms tools on the market. These features are: 1. The ability to build a complex form entirely within a Portal Environment, 2. The ability to assign the form to one or more categories, 3. The ability to deploy a single form or an entire category of forms to a Portal page through the FIT viewer, 4. The ability to perform dynamic data lookups from our data visualization product called the DIP to populate list oriented objects within the form configuration manager whether with a column list or a lookup from a provided static value or data from another form field. 5. The ability to include field validation regular expressions, 6. A built in graphical interface for mapping the form data to various targets being databases and web-services, 7. The ability to map multiple distinct submit events through the graphical interface to simultaneously send data to multiple systems upon end-user submission of the form, 8. The ability to order multiple forms in the FIT wizard to be presented as a single multi-part form in the Wizard viewer with Previous, Cancel, Save, and Next navigation built in as well as a navigable menu of all wizard sections, 9. The ability to perform all of these functions in a user-friendly graphical environment without the need for writing software code, 10. The inclusion of areas where advanced users can enter JavaScript code to control major form events, and 11. The ability to add a subform which inserts a table automatically and allows for the end-user to submit a subform within the graphical user interface of the Form Viewer.

### BRIEF DESCRIPTION OF THE FIGURES

FIG. 1 is a graphical user interface for Forms Configuration Management.

FIG. 2 is a graphical user interface for Forms Category Management.

FIG. 3 is a graphical user interface to add a new Forms Category.

FIG. 4 is a graphical user interface to edit a forms Category.

FIG. 5 is a graphical user interface to set form Active or Inactive.

FIG. 6 is a graphical user interface to Copy Form.

FIG. 7 is a graphical user interface to Reorder Forms.

FIG. 8 is a graphical user interface to set Form Name, Set as Active, and Assign to Category when creating or editing a form.

FIG. 9 is a graphical user interface to Set Form Header, Footer, and Stylesheet when creating or editing form.

FIG. 10 is a graphical user interface to create new fields, set field order, edit and delete fields.

FIG. 11 is the Create Field Selection Dropdown Menu that shows the types of fields available.

FIG. 12 is a graphical user interface to set Form Text Field Options.

FIG. 13 is a graphical user interface to set Form Banner Field Options.

FIG. 14 is the FIT form being displayed in the FIT viewer showing various fields including a banner field.

FIG. 15 is a graphical user interface to set Form Hidden Field Options.

FIG. 16 is a graphical user interface to set Form Text Area Field Options.

FIG. 17 is a graphical user interface to set Form Date and Time Field Options.

FIG. 18 is a graphical user interface showing the Form in the FIT viewer.

FIG. 19 is a graphical user interface to set field options as well as static or dynamic options for a list type field such as a dropdown, checkbox, or radio button.

FIG. 20 is a graphical user interface to set Form File Upload Field Options.

FIG. 21 is a graphical user interface to set Form Subform Field Options.

FIG. 22 is a graphical user interface to create submit events which determine where the data will be saved when the end-users submits the forms.

FIG. 23 is a graphical user interface to map the sources and data which will be loaded when the form is edited.

FIG. 24 is a graphical user interface to place the appropriate label onto the submit button (ie. SUBMIT, SAVE, etc.) and provide a means to navigate users to an alternate web destination on save (e.g. A thank you for Submitting page).

FIG. 25 is a graphical user interface to configure the Form Viewer.

FIG. 26 is a graphical user interface to select a category of forms to deploy into the Form Viewer.

FIG. 27 is a graphical user interface which the end-user may use to select and load a form to fill in.

FIG. 28 is a graphical user interface showing the menu of forms that the user may select.

FIG. 29 is a graphical user interface to select an individual form for deployment into the Form Viewer.

FIG. 30 is a graphical user interface for the end-user to complete and submit the form in the Form Viewer.

FIG. 31 is another view of the Form Viewer graphical interface showing the result of the Header and footer customization capability.

FIG. 32 is a graphical user interface for creating subforms to handle manyto one or many-to-many form relationships such as a company profile where one may wish to list many separate but related contacts.

FIG. 33 is a graphical user interface of the Wizard Configuration Manager main screen for navigating to, creating or editing a form Wizard.

FIG. 34 is a graphical user interface for adding forms to the Wizard and setting the order of the forms that will be included in a given wizard.

FIG. 35 is a graphical user interface for selecting a method for deploying a wizard to a portal page.

FIG. 36 is a graphical user interface for selecting and deploying a wizard to a portal page.

FIG. 37 shows that the forms in the wizard are now displayed as tabs and that the wizard navigation buttons have been added to the bottom of the wizard graphical user interface. Also shown is the Draft/Final functionality.

### DETAILED DESCRIPTION

### Form Integration Toolkit

The Fit, or “Forms Integration Toolkit”, Is a Portal Based form builder that allows an analyst level resource to create Portal based forms without writing code. There are provisions for power users to enhance the functionality provided with JavaScript. The outstanding feature of the FIT is the ability to send all or part of the data collected in the form to multiple data targets simultaneously. Included in the FIT is a forms wizard, which permits the form designed to create multiple forms then tie them together in a wizard, to walk the end-user through a process wherein they fill in each form in order and navigate through the wizard using Previous/Next controls.

### Configuration Manager

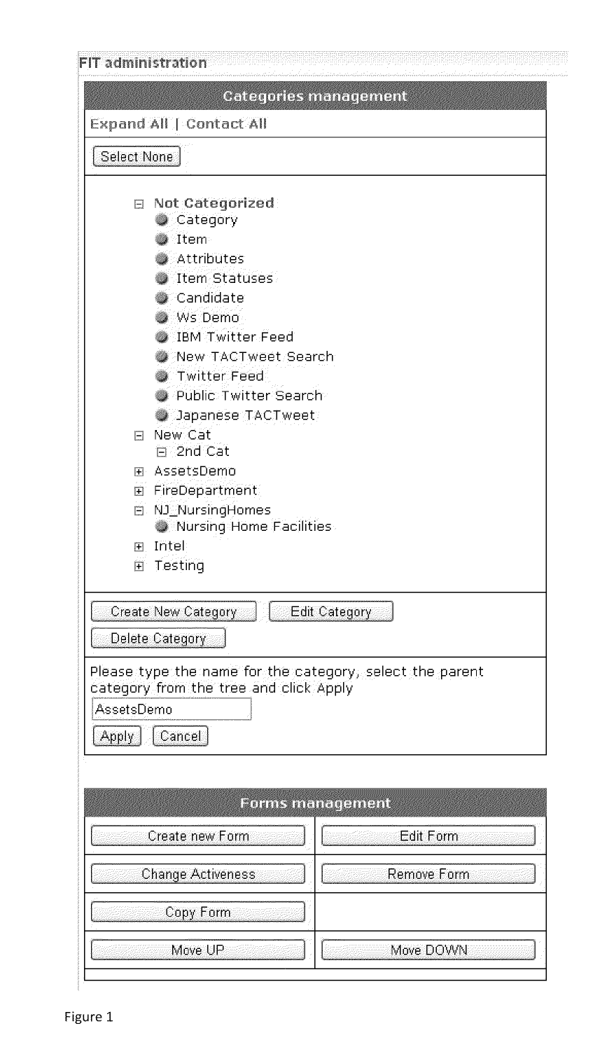

FIG. 1 shows the FIT Configuration Manager which is used for configuring forms.

### Categories Management

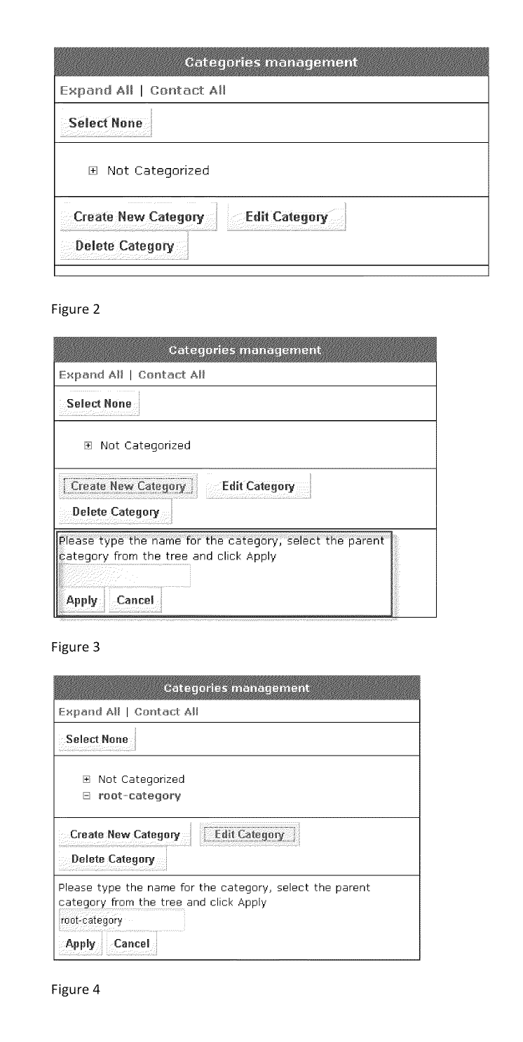

As can be seen in FIG. 2, the User is able to View, Add, Modify categories

### Create New Category:

As shown in FIG. 3, the user shall perform the following actions to create a new category:

1. Select Root category

2. Press “Create New Category”

3. The User specifies Name for new Category

4. After Apply is pressed:
a. If No category or “Not Categorized” are selected, category is created as root one
b. If a different root category is selected, new category is created as sub-category

### Modify Existing Category

As shown in FIG. 4, the user shall perform the following actions to modify a Form Category

1. Select category which should be modified

2. Select new root category

3. Type new name for the category

4. After Apply is pressed:
a. If no category or “Not Categorized” are selected, category is created as root one
b. If a different category is selected, new category is created as sub-category

### Remove Category

As shown in FIG. 4, the user is not able to remove “Not Categorized” category
1. User selects category to remove
2. If confirmed the category is removed. All subcategories removed also. If Form is not assigned to any other category, it is moved to the “Not categorized” category

### Forms Management

In the Forms Configuration Manager (FIG. 1) graphical interface, the User may perform the following tasks:

### Change Activeness of the Form

As shown in FIG. 5, active forms may be assigned to the Form Viewer for end users to interface with the form.
Not Active categories cannot be selected and assigned in the Form Viewer and cannot therefore not be deployed to end users

1. Select Form which form should be changed

2. Click “Change Activeness” button

3. Activeness of the Form is changed

### Copy Form Functionality

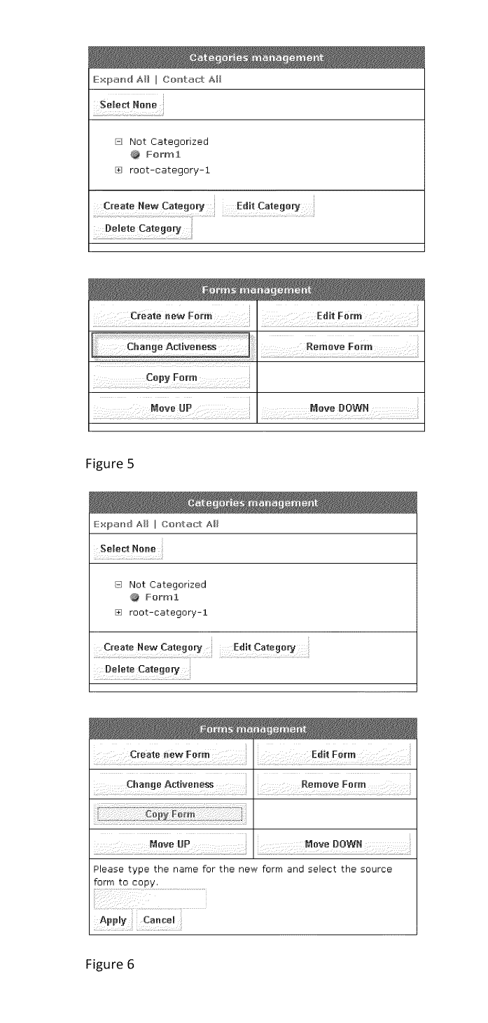

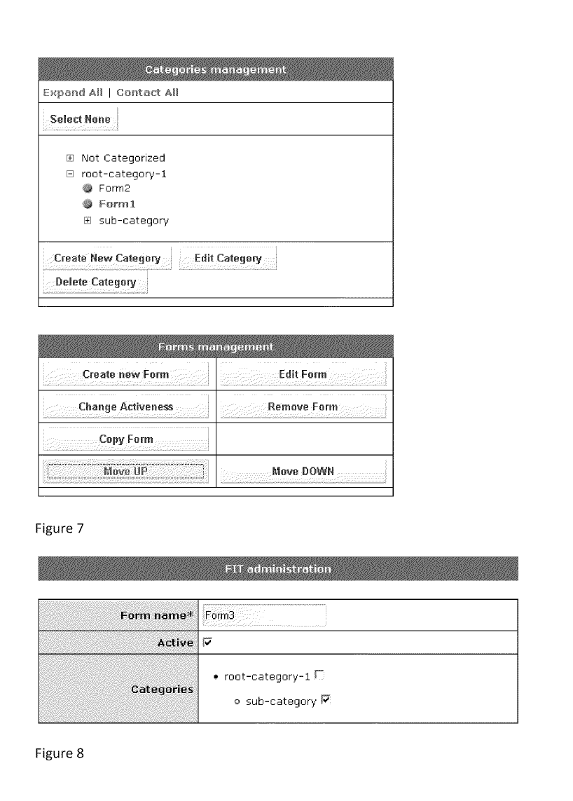

FIG. 6 shows the “Copy Forth” capability of the FIT Configuration Manager. It works as follows:
1. User selects the form to copy
2. User press Copy Form
3. User specifies Name for the new Form
4. When User clicks Apply new Form is created with specified Name. All assigned categories of the original Form are also copied
   Move Form Up/Down within Category
   FIG. 7 shows how to reorder forms within a category.

1. The User selects the form to be moved up/down

2. The User press Move Up/Move Down

3. Form is moved up/down

### Add New Form/Edit Existing Form

FIG. 1 shows the “Create New Form” button that is present within the FIT Configuration Manager

1. The User clicks Add new Form or selects the form to be edited and clicks Edit Form

### Basic Form Details

FIG. 8 shows the basic form details section wherein the user may perform the following functions:
1. The User specifies Name of the form
2. The User selects Activeness of the form
3. The User selects Categories in which the Form should appear. Any quantity of categories and sub-categories could be specified. If no categories selected, form is assigned to “Not categorized” in the viewer the form will appear in all categories selected. This is especially useful for forms that are part of multiple workflows or tasks.

### Header/Footer and Stylesheet

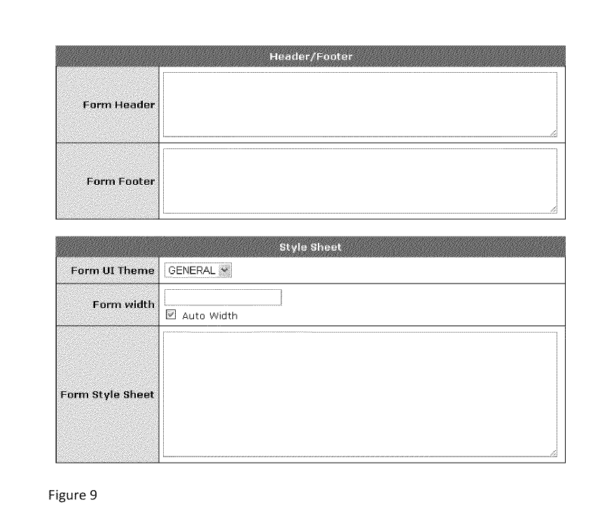

FIG. 9 shows the Edit Header and Footer, and Style Sheet graphical user interface. Whatever is entered here will appear above and below the form when displayed in the viewer accordingly.

1. The User specified Header and Footer
a. HTML tags could be used
b. Java Scripts could be written if desired, but is not necessary to configure and deploy a form.

2. The User can specify additional styles or modify styles in the Style Sheet section

3. Styles defined for single form, are applied only for this form in the Portlet

### Form Fields Section

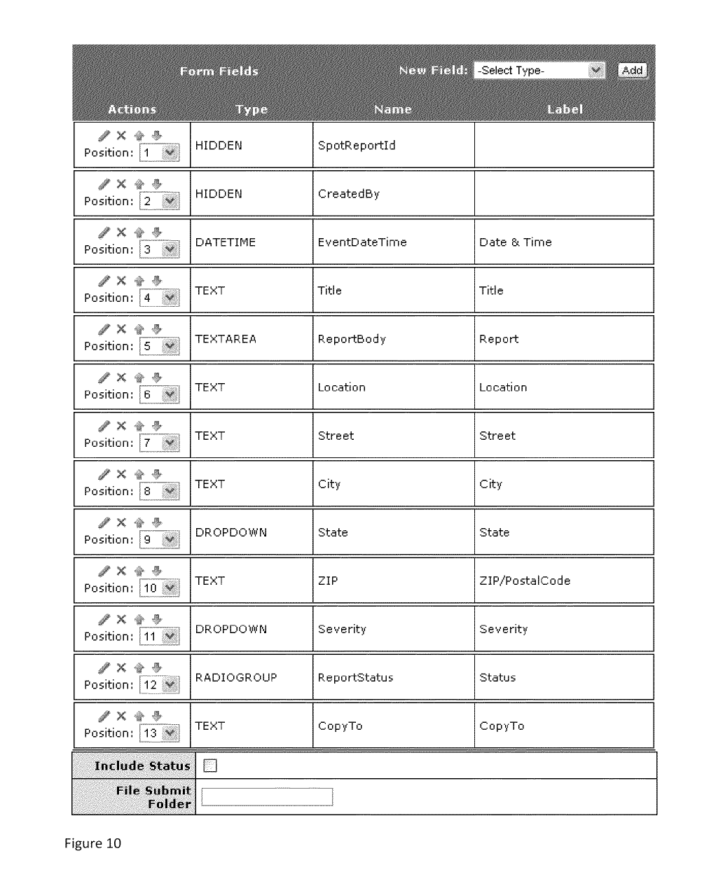

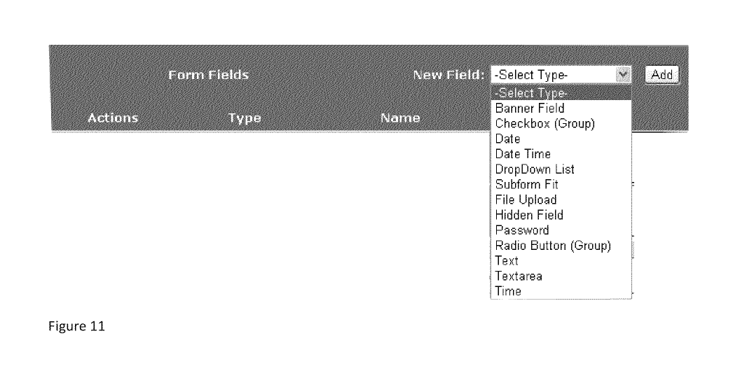

FIG. 10 shows the Form Fields section wherein the user shall define the fields that are in the form.
As shown in FIG. 11, the user shall first select the type of field to add to the form.
When the user then clicks the “Add' button (FIG. 10), the Field editing graphical interface is shown
There are several advanced features that may be used when creating fields as outlined immediately below:

### Default Values

1. To set a default value which will be automatically populated into the field for the End-User in the Form Viewer, static values (text) or tokens may be used, available tokens are as follows immediately below:
   a. Query parameter token: [QRY=<name>]
   b. User token: [USDET=<name>]
   c. Session token: [SESS=<name>]

### Field Visibility

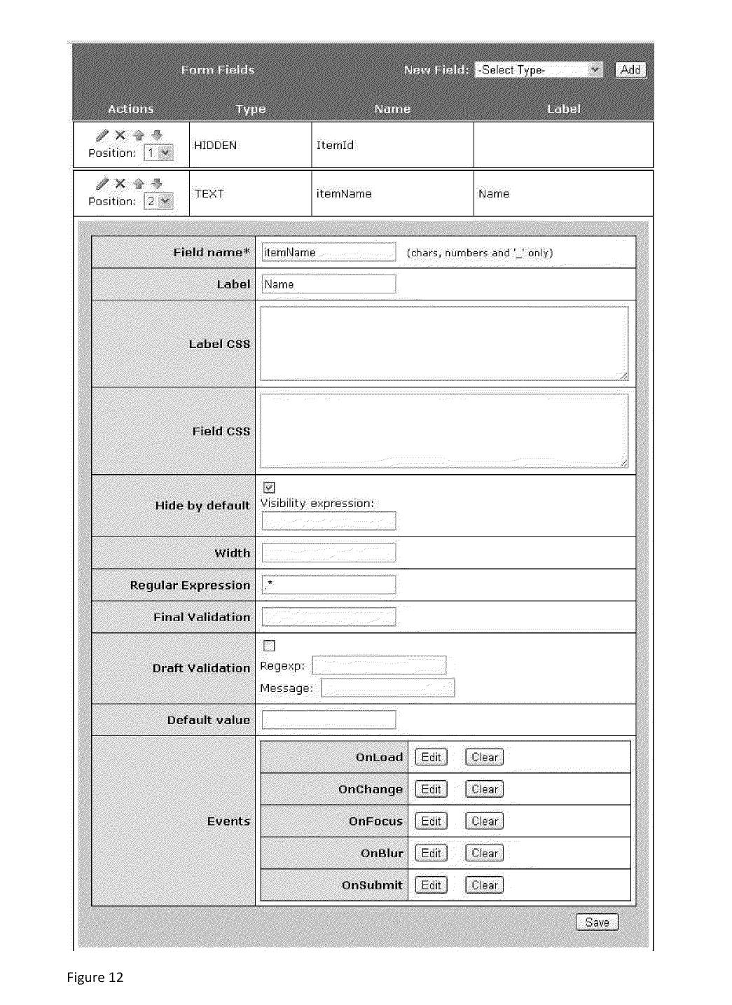

As shown in FIG. 12, a user is able to set visibility options for the field
Show/Hide functionality
1. To hide field b default user should tick the box “Hide by default”
2. When the input appears for the expression user could type in the expression for visibility. The Form Viewer at runtime, will check if the expression is TRUE the field is shown, otherwise it is hidden
3. If the Field is hidden, it is not submitted

### Hide Show Expression Language (HSEL):

Various functions may be written in the Visibility Expression field to control the field's visibility (FIG. 12).

### Available Functions:

1. equals—checks the equality case sensitive
2. equals_ic—checks the equality case insensitive
3. contains—checks if the left part of the expression contains the right part case sensitive
4. contains_ic—checks if the left part of the expression contains the right part case insensitive
5. starts_with—checks if the left part of the expression starts with the right part case sensitive
6. starts_with_ic—checks if the left part of the expression starts with the right part case insensitive
7. ends_with—checks if the left part of the expression ends with the right part case sensitive
8. ends_with_ic—checks if the left part of the expression ends with the right part case insensitive
9. not_equals—checks if the left part is not equal to the right part
10. >—math more
11. >=—math more or equals
12. <—math less
13. <=—math less or equals

### Logical Operands:

1. AND (and)—logical and

2. OR (or)—logical or

### Fields Referencing:

Any field can be referenced wrapping the field name with pound symbols. For example field name is: country, so the reference to the field value will be #country#

### Examples

Four fields are available on the form: country, city, county, address. User wishes for the address field to appear only when previous 3 fields are set and county field is ‘CountryDesired’. So the expression should be

#country#not_equals‘’AND#city#not_equals‘’AND#country#equals_ic‘CountryDesired’

Field Events are shown at the bottom of FIG. 12.
1. By clicking the Edit Events button, the Administrator can specify the following JavaScript events for every field:
   a. OnLoad behavior (all OnLoads will be called when the Form is opened)
   b. OnChange behavior
   c. OnFocus behavior
   d. OnBlur behavior
   e. OnSubmit behavior (all OnSubmits will be called when the Form is submitted)
      If the field JavaScript events are left empty by the administrator, then no specified event will be attached to the specified field):
2. Inside the JavaScript code, the administrator can access fields by field names (Field Name shown in table actually will be replaced with unique Field Name because different portlets could have fields with same Field Name) and forms using the following expression: #element_id# where element_id is the field Name specified in the table. This expression will be replaced with real Field Name of the element during runtime. For example (OnChange behavior of the field is Selected). Also in OnChange, OnFocus, OnBlur events, field for which event is fired could be accessed via keyword “this”. For Example:

```
if (document.getElementById(‘#isSelected#’).value == ‘correct’) {
  alert(‘correct’);
} else {
  alert(‘incorrect’);
}
if (this.value == ‘correct’) {
  alert(‘correct’);
} else {
  alert(‘incorrect’);
}
```

### Edit/Remove Move Up/Down Field

The Up and Down arrows shown in FIG. 12 are used to move the Field up and down relative to the other fields. The Pencil is used to load the Field for Editing (as shown). The red “X” is used to delete the field.

### Field Types

As can be seen in FIG. 11, there are many types of fields that can be added to a form, they are:

### Text Field

The Text Field graphical design interface is shown in FIG. 12. The items that may be defined are:
1. Field Name (not shown to the user)
2. Label (as shown to the User)
3. Label CSS—style sheet for the Field Label
4. Field CSS—style sheet for the Field
5. Hide By Default (see Field Visibility above)
6. Width—maximum field width
7. Regular expression: JavaScript regular expression to check against. (.*—any string by default)
8. Default Value
9. Events (see Field Events)

### Banner Field

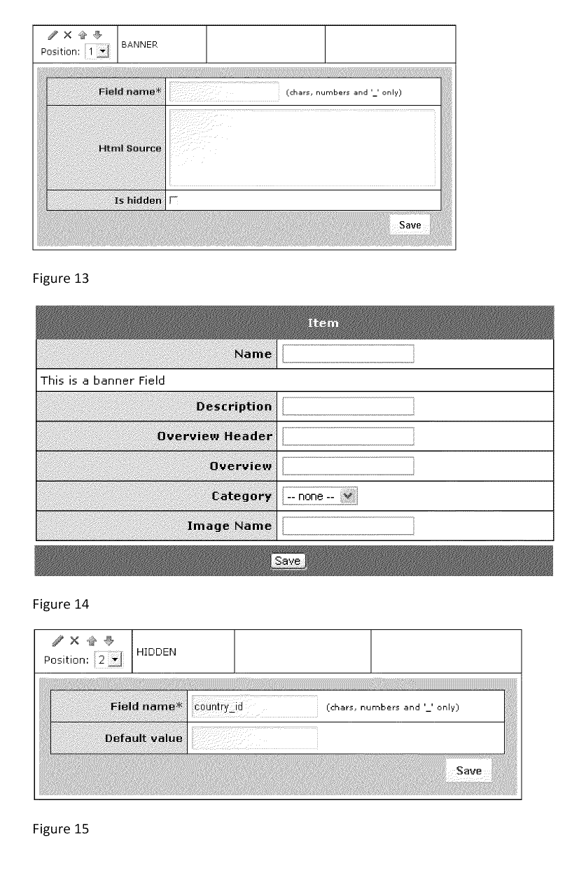

The Banner Field graphical design interface is shown in FIG. 13

1. Field name as will be shown on the Configuration page

2. HTML source—tags, scripts etc. is specified

3. “Is hidden”—if the Banner section is hidden

The Banner field is used for informational purposes to communicate with the end user. The styles specified in the Style sheet section available in Banner field. The banner field supports the entry and subsequent display in the Form Viewer of any valid text or HTML. FIG. 14 shops the Form displayed in the Form viewer at runtime and shows a banner field.

### Hidden Field

The hidden Field graphical design interface is shown in FIG. 15

1. The user specifies the field ID

2. The user specifies the default value for the field (using tokens if desired)

3. Hidden field is not shown to the User, but submitted to the DB from the viewer

### Password Field

The Password Field functions exactly as the Text Field with the exception that input is masked at runtime as it should be in a password field.

### Text Area Field

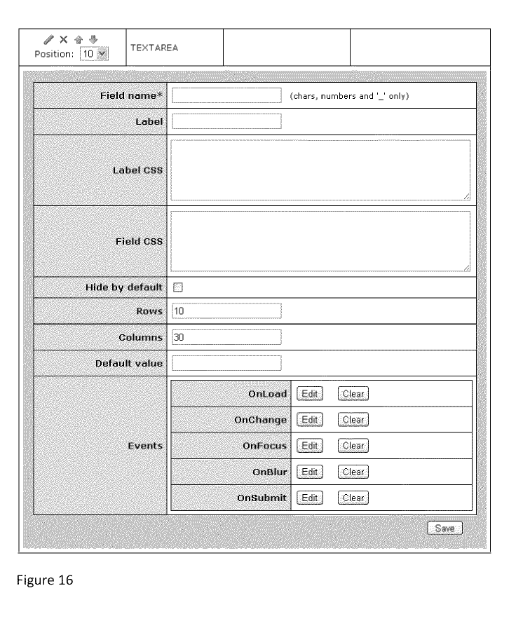

The Text Area Field graphical design interface is shown in FIG. 16. The items that may be defined are:

1. Field Name (not shown to the user)

2. Label (as shown to the User)

3. Label CSS—style sheet for the Field Label

4. Field CSS—style sheet for the Field

5. Hide By Default (see Field Visibility above)

6. Rows and Columns quantity

7. Default Value

8. Events (see Field Events)

### Date, Time, Date & Time Fields

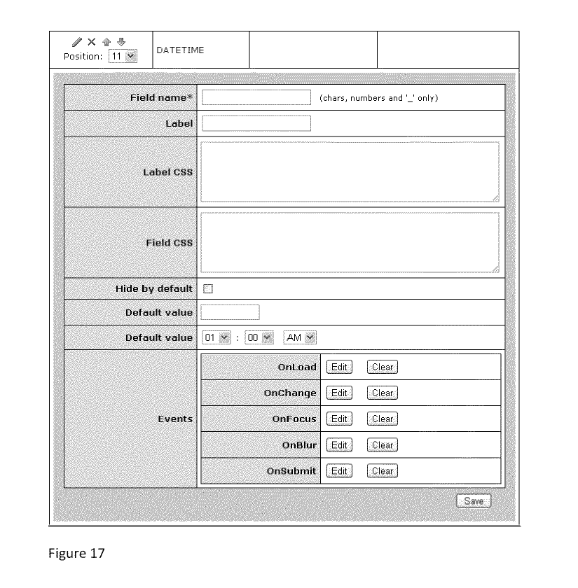

The Date, Time, Date & Time Field graphical design interface is shown in FIG. 17. The items that may be defined are:

1. Field Name (not shown to the user)

2. Label (as shown to the User)

3. Label CSS—style sheet for the Field Label

4. Field CSS—style sheet for the Field

5. Hide By Default (see Field Visibility above)

6. Default Value

7. Events (see Field Events)

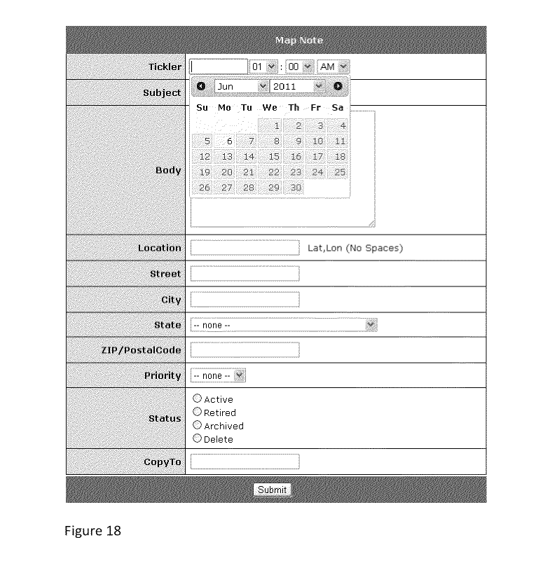

8. A menu popup will appear in the viewer for the Date type fields (FIG. 18).

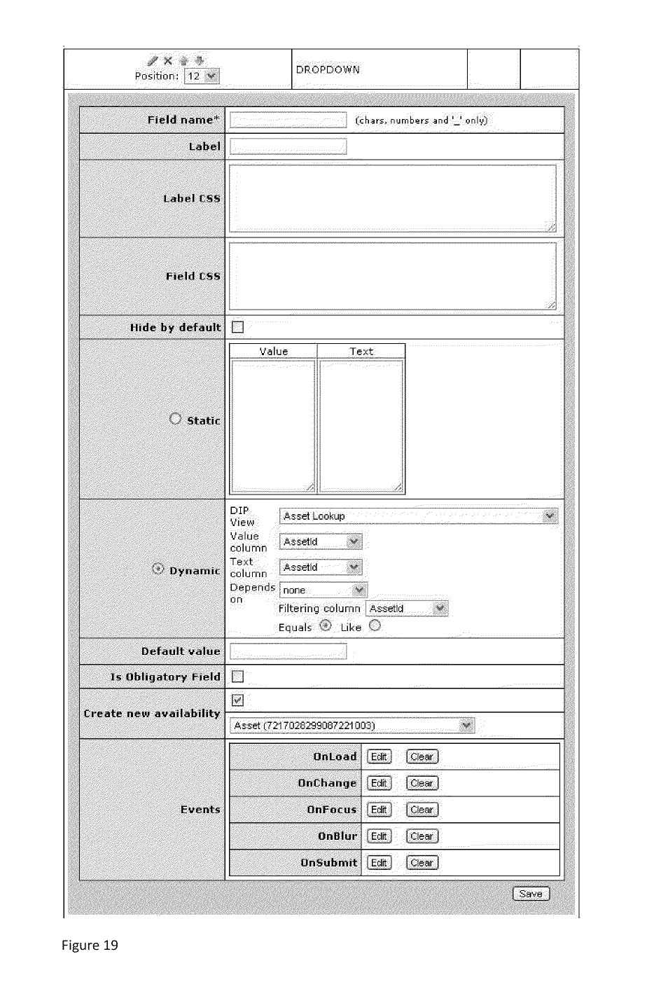

Checkbox, Radio button, Dropdown Fields
The Checkbox, Radio button, Dropdown Field graphical design interface is shown in FIG. 19. The items that may be defined are:
1. Field Name (not shown to the user)
2. Label (as shown to the User)
3. Label CSS—style sheet for the Field Label
4. Field CSS—style sheet for the Field
5. Hide By Default (see Field Visibility above)
6. Default Value
7. Events (see Field Events)
8. Static Data for List:
   a. Values Entered one per line (the value will be saved to the target on Submit in the Form Viewer)
   b. Text Entered one per line (Text will be displayed for the user in the list in the Form Viewer)
9. Dynamic Data
   a. A View is selected from the companion product called the Data Integration Portlet (DIP)
   b. Value and text columns should be specified
   c. Depends on may be selected (if the Field value depends on Value of another field)
      i. Field Name (value of selected field is used for dependent filtering)
      ii. Filtering Column (of current Field)
      iii. Filtering type: Equals or Like
10. Delimitier symbol. As multi values are stored in single column in DB, specified delimitier is used to split multiple values
11. Create new Availability (when new value is created, list of current values is updated):
   a. Static data—Add New functionality is automatically generated
   b. Dynamic Data—one of existing DIP Forms should be selected. In the User interface sub-form appears to submit new list Item

### File Upload

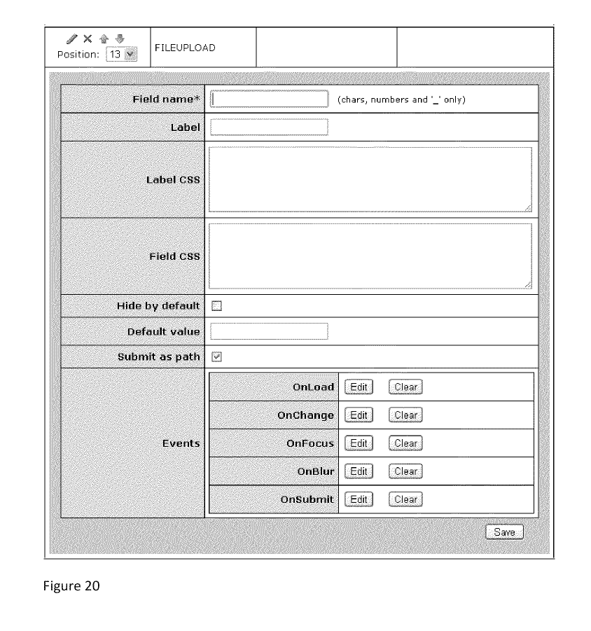

The File Upload Field graphical design interface is shown in FIG. 20. The items that may be defined are:

1. Field Name (not shown to the user)

2. Label (as shown to the User)

3. Label CSS—style sheet for the Field Label

4. Field CSS—style sheet for the Field

5. Hide By Default (see0 Field Visibility)

6. Default Value

7. Events (see Field Events)

### Sub-Form Field

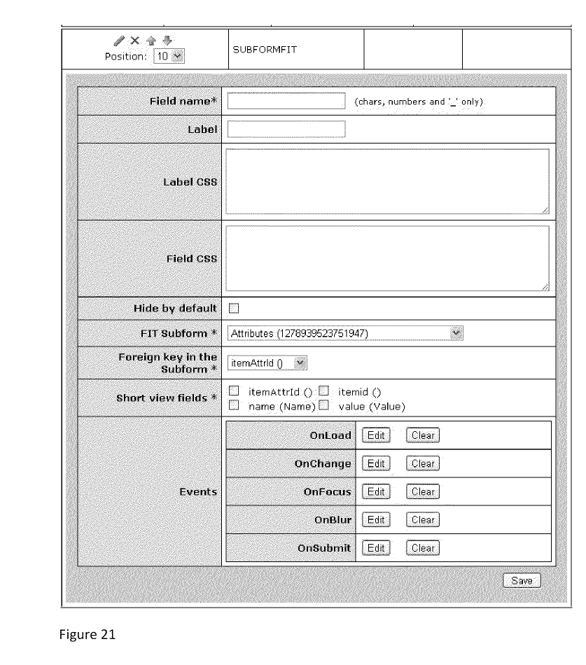

The Sub-Form Field graphical design interface is shown in FIG. 21. The items that may be defined are:

1. Field Name (not shown to the user)

2. Label (as shown to the User)

3. Label CSS—style sheet for the Field Label

4. Field CSS—style sheet for the Field

5. Hide By Default (see0 Field Visibility)

6. FIT Subform—one of existing forms

7. Foreign key in the Subform: one of fields of the Subform which is used as Foreign key

8. Show view fields: which fields are shown in the basic table details

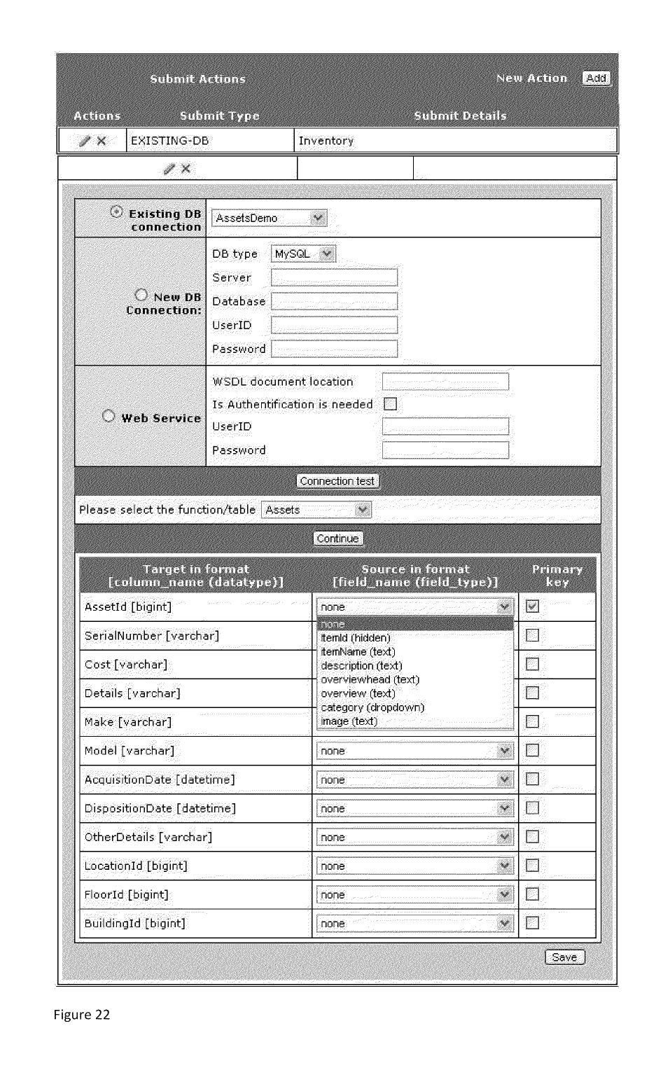

This field appears to user as “1-N” connectivity between DB tables.
Data from Sub-form Field is submitted to the DB configured for the Sub-Form
Submit Actions section
The user is able to specify any quantity of Submit actions for the Form as depicted in FIG. 22.
1. The user clicks Add
2. The user selects one of:
   a. Existing DB (one of DIP Connections)
   b. New DB connection
      i. DB Type
      ii. Server
      iii. Database
      iv. User name
      v. Password
   c. Web Service:
      i. WSDL location (http:// . . . )
      ii. Authentication details:
         1. User name
         2. Password
3. The user presses Connection Test (list of all available/accessible tables/functions is shown)
4. The user presses Continue to Map fields to Columns

### Edit Mode Configuration

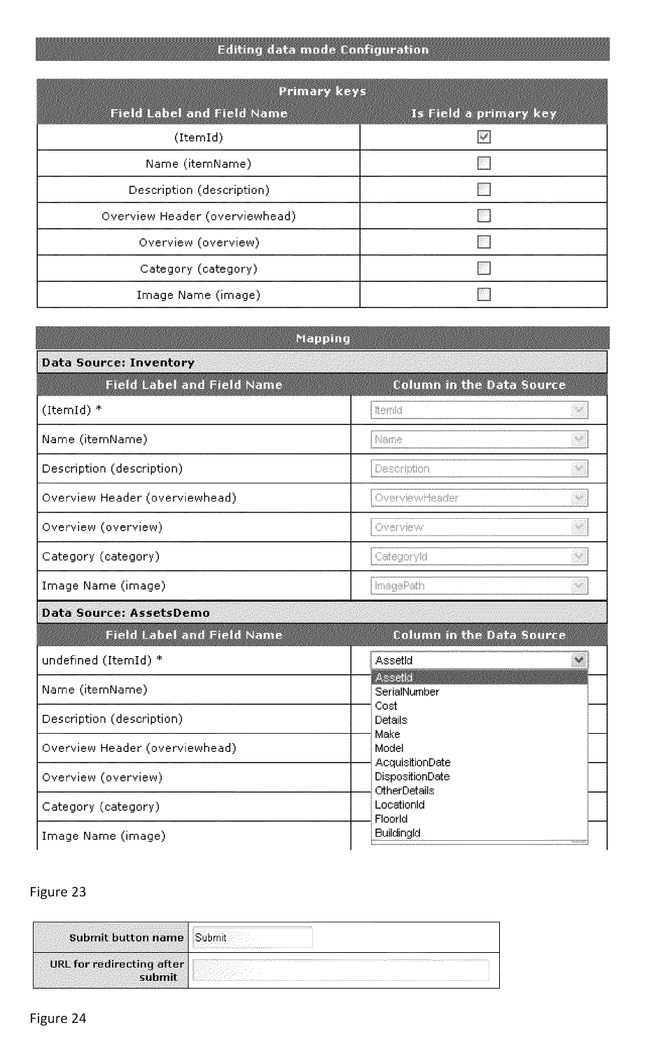

The graphical user interface for creating Edit mode mappings is shown in FIG. 23.
1. The user selects Primary Keys
2. The user selects from which data source which data should be loaded for Edit Mode
3. Mapping should be configured in such way, that one field should be prefilled from only one data source column

### Submit Button and Redirect

The graphical user interface for the Submit Button and Redirect functionality are shown in FIG. 24.
1. The user specifies the Submit button name
2. The user specifies the redirecting URL (when Form is submitted redirection is done to specified URL)

### Form Deployment

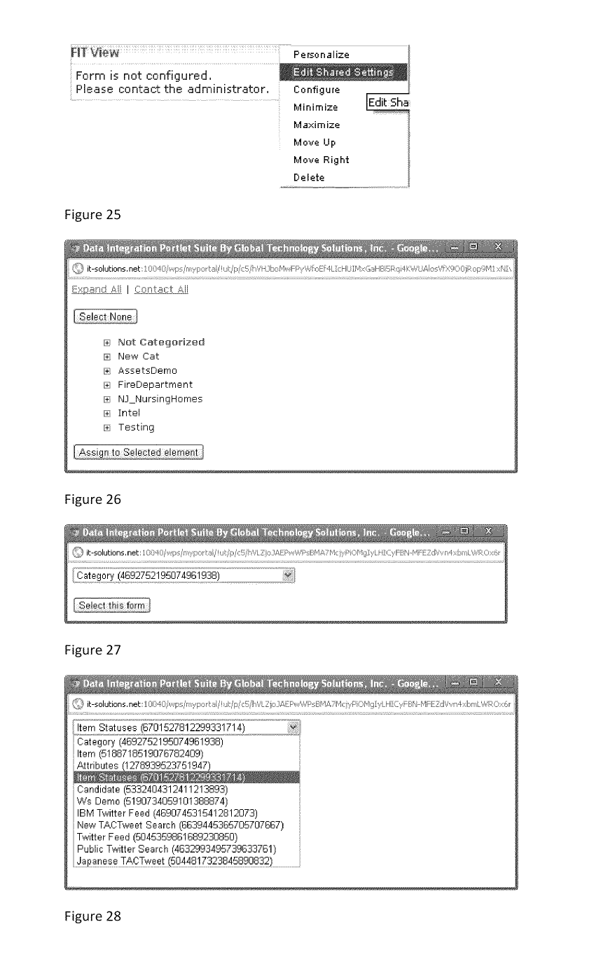

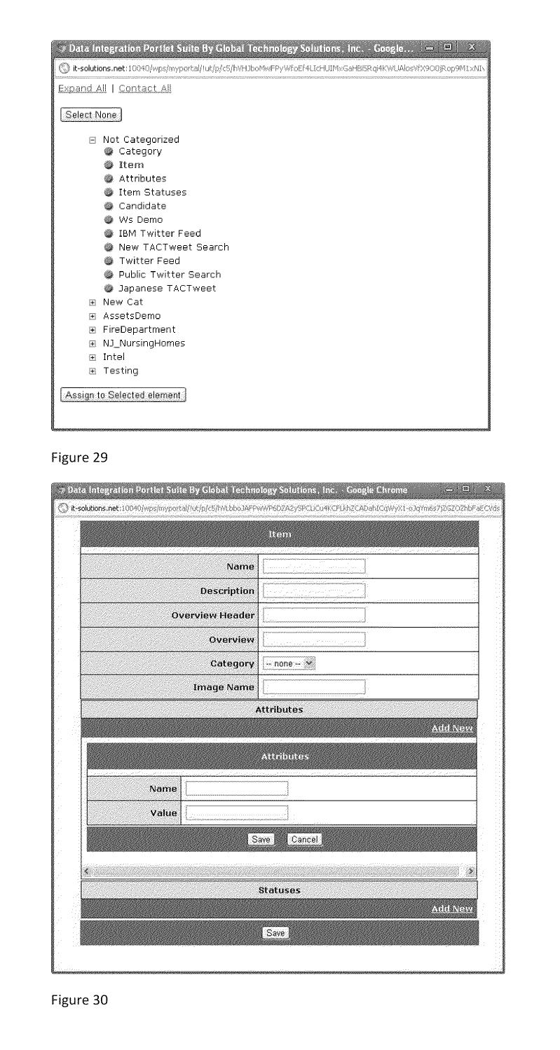

1. The user selects “Default Preferences” or “Edit Shared Settings” depending on the particular portal manufacturer. As shown in FIG. 25.
2. The user then selects Category (any form from category is able to be submitted by the end user) or Form
3. The user presses “Assign to Selected element”
4. If a Category is selected, then a list of forms that are members of the selected category will be displayed of which the user may select one to enter and submit data (FIGS. 26-28)
5. If a form is selected, then just the selected form will be displayed within the portlet (FIGS. 21 and 22)

### View Form

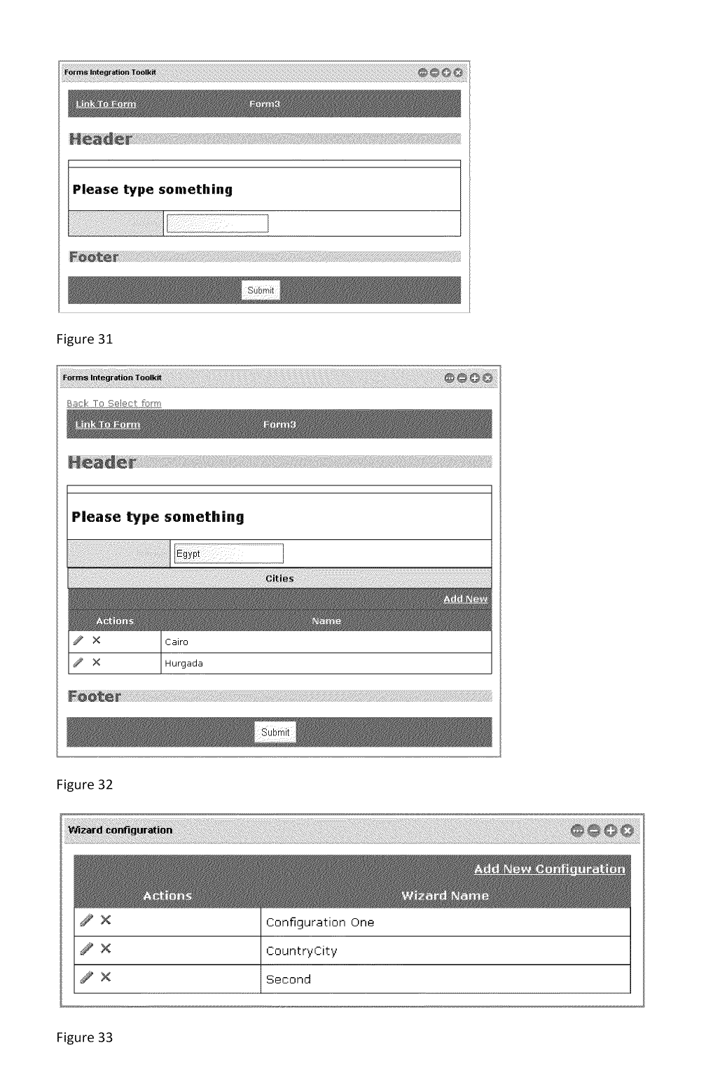

FIGS. 31 and 32 show the Deployed form. The different colors show how Styles can be used to easily customize the look and feel of the Forms.
Once data is submitted the user is able to update the form data clicking “Link to Completed Forth” as can be seen in FIG. 32. FIG. 32 also shows an embedded Subform.
Data is synchronized in all data sources mapped with Submit Events when user clicks “Submit”
Interaction with DIP
The DIP is the View Product that is another member of the same suite of products as the FIT.
The DIP is used as a navigation mechanism to view the entered data as well as select a record for editing.
In order to open a FIT in editing mode using DIP, URL should contain the following additional query tokens:
editingModeOn=true
set of query tokens which describes primary key for opening entry for editing (see section with Edit Mode Configuarion)
   field_name (as specified in the FIT)=field_value
      If more than one primary key is specified for FIT, all primary keys should be provided to the URL

### Example:

http://example.com/?someparam=1&editingModeOn=true&primaryField=field Value

### FIT Wizard

The FIT Wizard enables users to use all active FIT to make a multi-part form or “wizard”

### Wizard Configuration

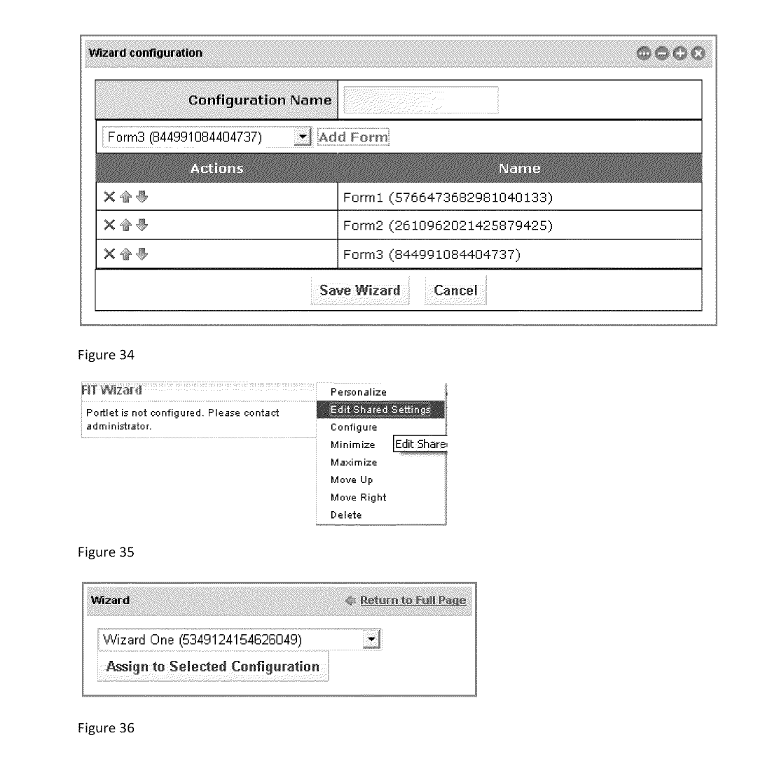

The FIT Wizard configurations are managed in the Wizard Configuration Manager shown in FIG. 33
1. The Configuration name must be specified during configuration
2. Set of forms included should be specified for the Wizard by selecting a form from the dropdown list and clicking “Add Forth”
3. Forms can be reordered and deleted using the controls that are presented in the left column as shown in FIG. 34.

### Wizard Deployment

The FIT Wizard is deployed much the same as the FIT Form. As shown in FIGS. 35 and 36, the user simply adds the FIT Wizard Viewer Portlet to a portal page, then chooses Edit Shared settings or similar (again, depending on the portal manufacturer, then selects the Wizard to deploy and clicks “Assign to Selected Configuration”
Once the Wizard is configured the user is able to:

Start a New Wizard

View the Navigator for the Wizard forms

To start, the user should select the first Wizard tab on the left side
Once the user has filled the first tab (form) and presses “Next”, currently modified section is marked as completed/draft. Data in the form is saved into the DB and preloads (like in Editing mode for FIT)
Based on updated information in the Database, all Wizard steps the user through each form (changing data on current step could change data on next steps. For example: First Step->Create Candidate, second select skill. On the second form list of all Candidates exist. This list is updated once the Candidate is saved on the First Step)

### FIT and Wizard Interaction

Unless the FIT contains a special field, showing current document status (draft or final), the submitted form is always treated as FINAL.
In order to provide an ability to select if the form is final or draft the user should add DROPDOWN/RADIOBUTTON field to the FIT with defined name “documentstatusfield” which may or may not be saved to the database.
Two values of the field are acceptable:

documentDraft—for the draft status

documentFinal—for the final status

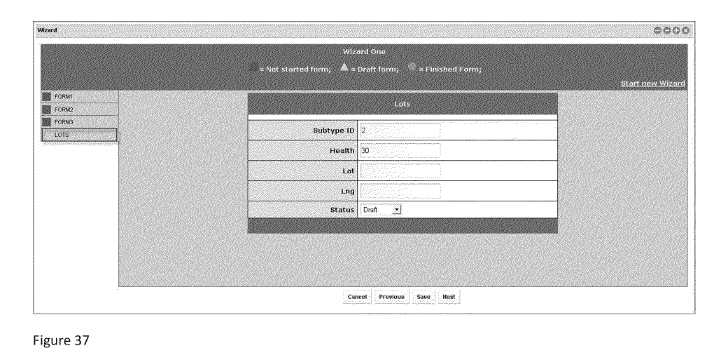

If the current selected value is “documentDraft”, draft icon is shown near the completed form as seen in FIG. 37

The invention claimed is:

1. A computer storage medium comprising computer-executable instructions for performing the steps of:
receiving form definition instructions;
in response to the form definition instructions, creating a form defining fields for receiving data to be entered by form users;
receiving mapping instructions specifying multiple targets, including databases and web-services, to populate with the data received through the form;
storing a mapping between the form and the targets in accordance with the mapping instructions;
receiving data entered into the form by a plurality of form users;
sending all or a portion of the data collected through the form to each target as defined by the mapping; and
wherein the form and the mapping instructions are submitted by a form publisher through a single submit event.
